(19) United States
(12) Patent Application Publication
(10) Pub. No.: US 2012/0229501 A1
(43) Pub. Date: Sep. 13, 2012

(54) Method and a Computer System for Displaying and Selecting Images

(75) Inventors: Kaoru Hosokawa, Tokyo (JP); Kohji . Nakamori, Kanagawa (JP)

(73) Assignee: INTERNATIONAL BUSINESS MACHINES CORPORATION, Armonk, NY (US)

(21) Appl. No.: 13/478,877

(22) Filed: May 23, 2012

Related U.S. Application Data
(63) Continuation of application No. 10/444,868, filed on May 23, 2003, now abandoned.
Application No. 10/444,868 is a continuation of application No. 09/542,165, filed on Apr. 4, 2000, now abandoned.

(30) Foreign Application Priority Data
May 17, 1999 (JP) 11-136012

(51) Int. Cl. G09G 5/00

(52) U.S. Cl. 345/620

(57) ABSTRACT

A method and an apparatus are disclosed for simultaneously displaying different images in one whole image display area, and easily performing the switching and selection of display. The present invention distinguishes subtle differences between images by partitioning a whole image display area into several parts, and simultaneously displaying images before and after processing, or images that are results of different processing. Furthermore, so as to easily distinguish which image is currently selected, a selection frame is displayed around the image selected. In addition, so as to easily switch the display of images, a user interface is realized, that makes it possible to easily switch display methods without clicking by a system detecting a cursor position of a pointing device, and that makes it possible to easily select a desired image by clicking.

### CROSS REFERENCE TO RELATED APPLICATIONS

This application is a continuation of U.S. patent application Ser. No. 10/444,868, filed May 23, 2003 which is a continuation of U.S. patent application Ser. No. 09/542,165, filed Apr. 4, 2000, now abandoned, incorporated by reference herein.

### FIELD OF THE INVENTION

The present invention relates to a method and apparatus for performing image display with which a user easily compares the difference between images before and after processing, or images which are the results of different processing, when a photographic image acquired from a digital camera, a scanner, or a folder is processed in a computer system. Furthermore, the present invention realizes a user interface through which a user can easily switch or select display when the user displays or selects a desired image among images displayed.

### BACKGROUND OF THE INVENTION

Heretofore, an application program displaying results of image processing of photographic images, as shown in FIG. 1, displays images before processing and images after processing in different areas. In addition, image processing in the specification of the present invention includes the following processing techniques discussed, for example, in “Master of Digital Camera, Version 1.0, Users Guide (SC88-3190), (IBM Japan, Ltd.),” incorporated by reference herein.

### (1) Special Effect Processing

Various special effects such as blurring effect processing, embossing effect processing, and sharpening effect processing are applied to images.

### 2) Automatic Correction

Process of brightening a photograph darkly taken or correcting color balance by automatically adjusting tone curves of an image.

### (3) Saturation

Process of changing a color photograph into an old-fashioned photograph by changing the color photograph into a black and white photograph or a sepia photograph. In addition, it is possible to change color into the user's favorite color besides black and white, and sepia.

### (4) Resizing

It is possible to transform the resolution (size) of an image, for example, to generate a thumbnail to be pasted in a Web page, and to trim a useless part that is around the image.

### (5) Image Format Conversion

Image format conversion such as color reduction from a full-color format to, for example, a 256-color format.

Therefore, since images are displayed in different areas as shown in FIG. 1, when subtle differences between images before and after such processing or images which are the results of different processing, are compared, it is extremely difficult to distinguish, for example, subtle color differences.

A need exists for a method and a system for making it possible to simultaneously display images before and after processing, or images which are results of different processing, by dividing one image display area into pieces so as to easily compare subtle differences between the images before and after the processing or images that are results of different processing.

A further need exists for a user interface that makes it possible to display images by easily switching display methods, such as, a display method of simultaneously displaying by arranging a part of an image before processing and a part of an image after the processing on one image display area, a display method of displaying a whole image before processing, and a display method of displaying a whole image after processing. Still another need exists for a user interface that makes it possible to simultaneously display images before and after processing, or image, which are results of different processing, by dividing one image display area, and to easily select a desired image.

### SUMMARY OF THE INVENTION

The present invention distinguishes subtle differences between images by simultaneously displaying an image before processing and an image after the processing, or images, which are results of different processing, by dividing a whole image display area. In addition, it is possible to select various partitions as a partition of a display area.

Furthermore, the present invention makes it is possible to make a user recognize at a glance which image the user selected by displaying a selection frame around the image selected when several images are each displayed in a partitioned portion of a whole image display area.

For example, by changing the color of a selection frame when an image before processing is selected from the color when an image after processing is selected, a user can rapidly see which image is selected from the images before and after the processing.

Furthermore, in the present invention, so as to realize a user interface that can easily switch the image display when images before and after processing, or image, which are results of different processing, are simultaneously displayed by dividing one display area, the system detects the cursor position of a pointing device and then, if the cursor is on a masked area of the image before processing, the system displays a whole image of the image before processing, and if the cursor is on a masked area of the image after processing, the system displays a whole image of the image after processing. Furthermore, if the cursor is outside a whole masked area, the system displays a part of the image before processing and a part of the image after processing by dividing the whole image display area.

In addition, so as to make it possible to also easily select a desired image, it is possible to select the desired image simply by clicking the desired image or the inside of a selection frame thereof.

A more complete understanding of the present invention, as well as further features and advantages of the present invention, will be obtained by reference to the following detailed description and drawings.

### DESCRIPTION OF THE DRAWINGS

FIG. 1 is a drawing showing a conventional image display system;

FIG. 2 is a drawing showing a screen of an image processing program to which the present invention is applied;

FIG. 3 is a hardware block diagram of one embodiment of the present invention;

FIG. 4 is a software block diagram of the present invention;

FIG. 5 is a block diagram of an image comparing and selecting module of FIG. 4;

FIG. 6 includes conceptual diagrams of a mask;

FIG. 7 is a flowchart of an initial setting of the present invention;

FIG. 8 is the first part of a flowchart showing the operation of a rendering module;

FIG. 9 is the second part of a flowchart showing the operation of a rendering module;

FIG. 10 is the third part of a flowchart showing the operation of a rendering module;

FIG. 11 includes drawings showing the process of rendering by the rendering module;

FIGS. 12(1) to 12(3) are drawings showing area detection by an area detecting module;

FIG. 13 is a flowchart of the operation of the area detecting module;

FIG. 14 is a flowchart of the operation of a selection state information generating module;

FIG. 15 is a flowchart of a focus information generating module; and

FIG. 16 includes drawings showing focus information and display states.

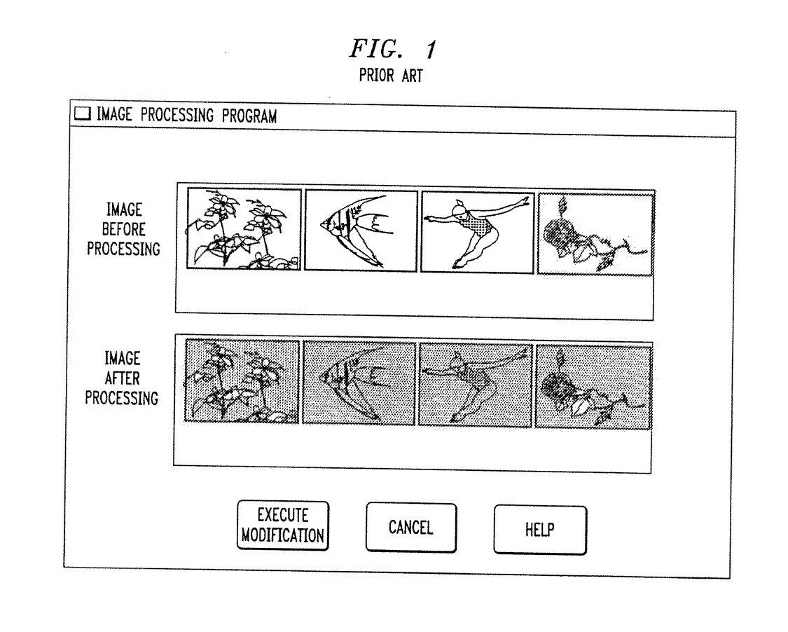

### DETAILED DESCRIPTION OF PREFERRED EMBODIMENTS

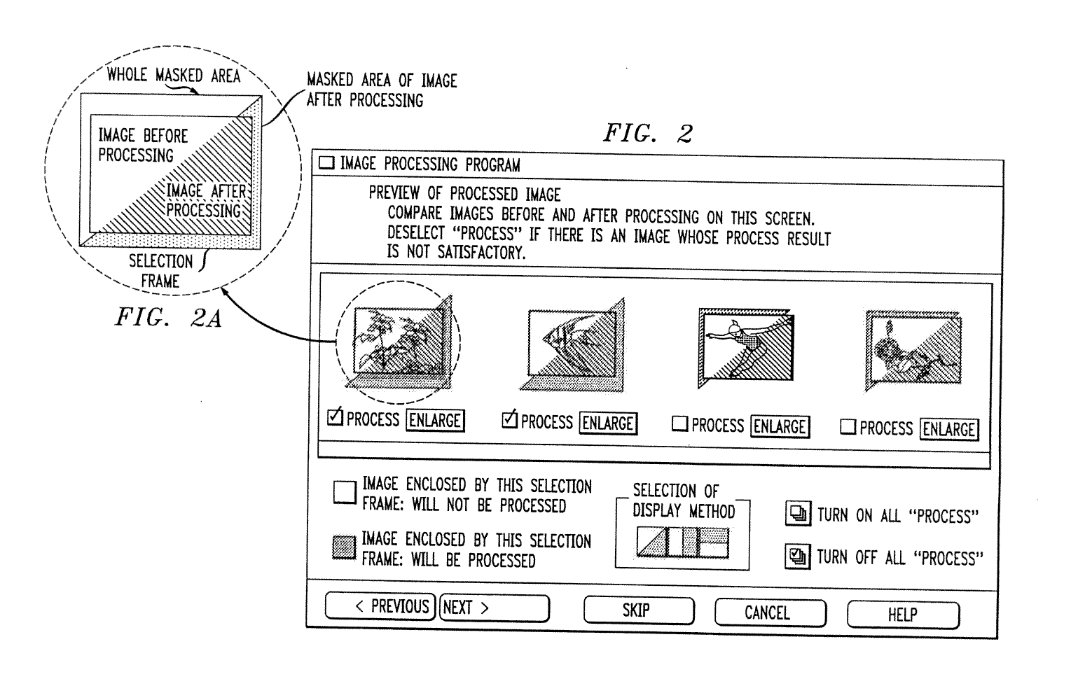

FIG. 2 shows an example of screens of an image processing program to which the present invention is applied.

In addition, in this specification of the present invention, a part generated by combining a “display area of an image after processing,” which is shaded with diagonal lines, with a “display area of a selection frame of an image after processing,” which is shaded with dots, as shown at the top of FIG. 2, is called “inside of a masked area of an image after processing.”

Similarly, also in regard to an image before processing, a part generated by combining “a display area of an image before processing” with a “display area of a selection frame of an image before processing” is called a “masked area of an image before processing.”

Furthermore, a part generated by combining a “display area of an image before processing” with a “display area of an image after processing” 0 is called a “display area of a whole image,” and a part generated by combining a “masked area of the image before processing” with a “masked area of the image after processing” is called a “whole masked area.”

In addition, as an embodiment of the present invention, a case where an image before processing and an image after processing are simultaneously displayed within one whole image display area which is divided will be exemplified and described.

The two left images in a screen of the image processing program that is shown in FIG. 2 are example cases of selecting images after processing as these can be seen from such a fact that check boxes labeled “process” are checked. Therefore, each selection frame is displayed around each image after processing.

In addition, the two right images shown in FIG. 2 are examples of selecting images before processing. In drawings attached to this specification, the color difference between selection frames is expressed as the difference of shadings of the selection frames.

As for the hardware configuration of the present invention, as shown in FIG. 3, a computer 101 comprises a CPU 102 including a microprocessor, peripheral circuits thereof, or the like, a memory 103 including a semiconductor memory or the like, a main storage 104 such as a hard disk drive or the like, and an external storage 105 such as a floppy disk, a CD-ROM drive or the like.

An output of an application program is displayed on an external display means 106. The display means 106 must be able to display a bit map image. In addition, it is desirable for the display means 106 to be able to display a color image. An instruction to the application program is performed with a pointing device 107 such as a mouse.

An operating system and application programs including the present invention are stored in the main storage 104, and are loaded into the memory 103 at the time of execution. Images to be processed are stored in the main storage 104 or the external storage 105, and are loaded into the memory 103 and processed at the time of use. If only the main storage 104 is used for storing the images, the external storage 105 is unnecessary.

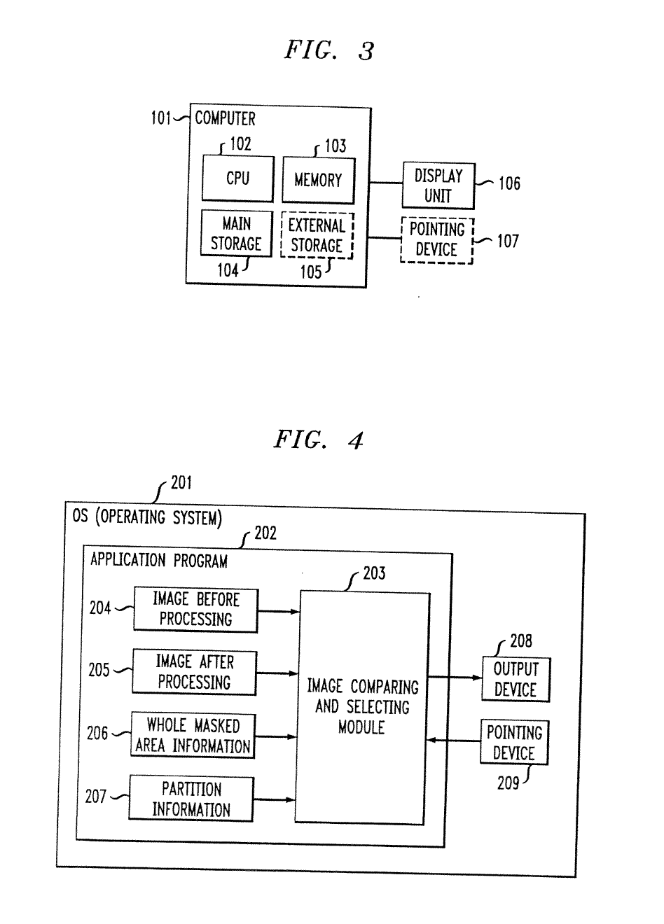

In addition, an example of the configuration of the software to which the present invention is applied is shown in FIG. 4. The software according to the present invention operates as one of application programs 202, and is effective mainly for application to an image processing application program.

First, as methods of acquiring an image before processing 204, there are the following methods. They are a method of acquiring an image file from a digital camera or a scanner to a hard disk drive in a personal computer, a method of acquiring an image file recorded on a recording medium such as a photo CD, a diskette, a magneto-optical disk (MO), or the like, and a method of down-loading an image file from the Internet or acquiring a photograph taken with a film camera after digitizing the photograph.

An image before processing 204 acquired by an above-described method is loaded by an application program, and is input to an image comparing and selecting module 203. Furthermore, an image after processing 205 to which an arbitrary image processing is performed is also input into the image comparing and selecting module 203. Besides them, whole masked area information 206, which shows where the image is displayed in an output device, and partition information 207 relating to a partition of a masked area of the image before processing on the whole masked area and a masked area of the image after processing are input into the image comparing and selecting module 203. In addition, the startup of the application program, input of information from pointing device 209, output of information to the display means, or the like are performed via the operating system (OS) 201. When the pointing device is operated, the OS 201 transmits information to the application program 202, the application program 202 can acquire the information of cursor coordinates and clicking of buttons. In addition, an image rendering library of the OS is used for an output to the display means, and the output is performed by rendering the image in a virtual output device 208. When rendering is performed in the output device, the OS transmits the output to the actual output device. It is possible to access the information of the pointing device and the output device from the image comparing and selecting module 203.

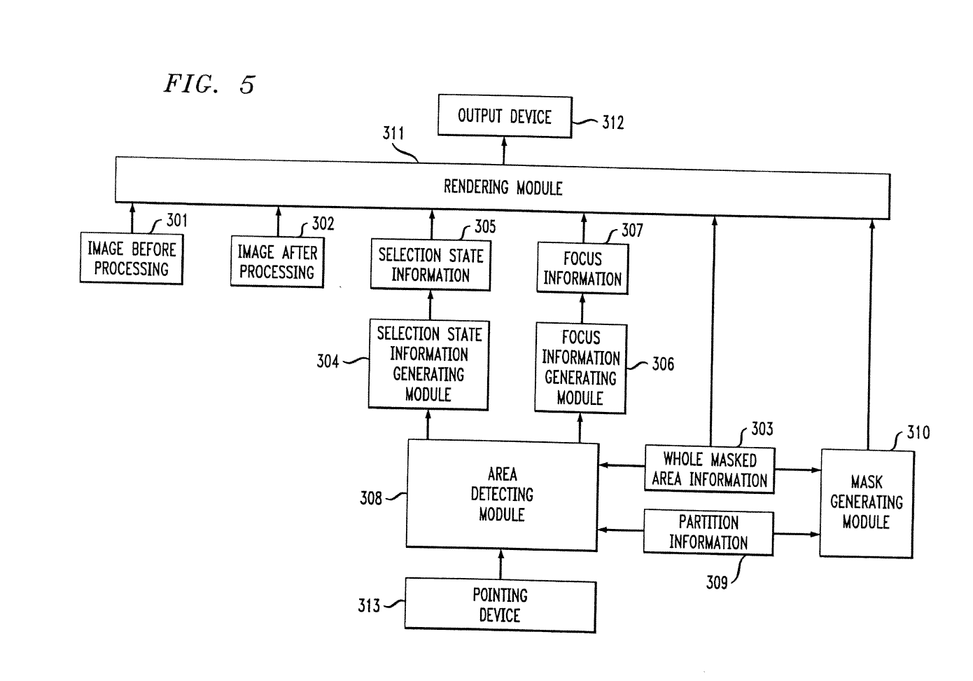

Next, the configuration of the image comparing and selecting module 203 that becomes the subject of the present invention will be described by using FIG. 5. An image before processing 301 and an image after processing 302 that are objects of comparison and selection are held in memory respectively. Whole masked area information 303 is the information given by the application program, and images and selection frames are rendered in this whole masked area.

An area detecting module 308 decides whether a cursor of a pointing device 313 is “outside of the whole masked area,” whether it is “inside of the masked area of the image before processing,” or whether it is “inside of the masked area of the image after processing.” Furthermore, the module 308 outputs the cursor position information to the selection state information generating module 304. Then, the selection state information generating module 304 is activated when a button of the pointing device is clicked, and updates selection state information 305 according to the cursor position.

Since the selection state information 305 holds information of whether the masked area of the image before processing is selected, or whether the masked area of the image after processing is selected, it is possible to know which image, before processing or image after processing, is selected by accessing the selection state information from the application program.

A focus information generating module 306 is activated when the cursor of the pointing device is moved, and updates focus information 307 according to the cursor position. The focus information 307 holds the cursor position information, that is, whether the cursor of the pointing device is “outside of the whole masked area,” whether it is “inside of the masked area of the image before processing,” or whether it is “inside of the masked area of the image after processing.” A rendering module 311 uses this information to display the whole image of the image before processing on the whole image display area, if the cursor is in the “inside of the masked area of the image before processing”. Similarly, if the cursor of the pointing device is “inside of the masked area of the image after processing,” the rendering module displays the whole image of the image after processing on the whole image display area. Furthermore, if the cursor of the pointing device is “outside of the whole masked area,” the rendering module simultaneously displays both the image before processing and image after processing by dividing the whole image display area. Therefore, the system automatically decides the cursor position of a mouse without clicking the button of the pointing device and switches display according to the cursor position. Therefore, it is possible to realize a user interface that is very easy for a user to use.

An area detecting module 308 decides the cursor position, that is, whether the cursor of the pointing device 313 is “outside of the whole masked area,” whether it is “inside of the masked area of the image before processing,” or whether it is “inside of the masked area of the image after processing.” Furthermore, the module 308 outputs the cursor position information to the focus information generating module 306.

Partition 309 holds a partition information of the whole masked area. First, what form is used for display is given by the application program. On the basis of this information, a mask generating module 310 generates a mask corresponding to the partition information. In addition, in the area detecting module 308, the partition information 309 is used also at the time of deciding whether the cursor is inside the masked area of the image before processing, whether the cursor is inside the masked area of the image after processing, or the like.

A rendering module 311 renders a selection frame according to the image before processing 301, image after processing 302, and selection state information 305 in the area given by the whole masked area information 303 to an output device 312. Thus, if the image before processing is selected, the rendering module 311 renders a selection frame around the image before processing. In addition, if the image after processing is selected, the rendering module 311 renders a selection frame around the image after processing in an aspect different from the selection frame around the image before processing (for example, a different color). Owing to this, since it can be seen at a glance which image is selected, it is possible to realize an easy-to-use system.

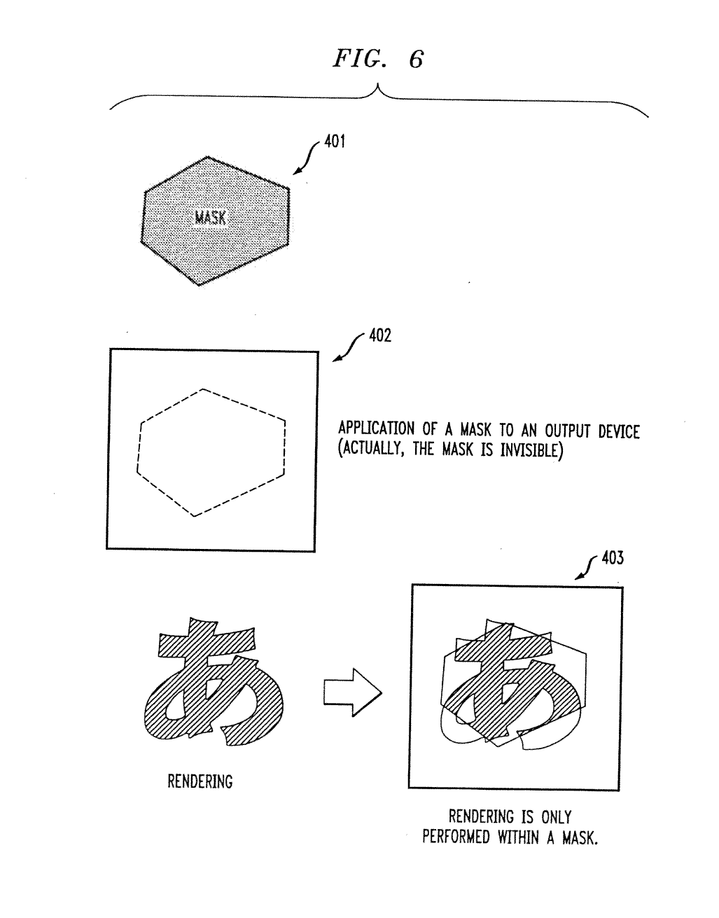

Here, a mask used at the time of rendering will be described with reference to FIG. 6. A mask 401 is a function of a rendering library of the OS, and is also called a clipping area or a region. By application of the mask to an output device (402), the subsequent rendering operation in the output device is affected. In other words, the rendering operation inside the mask becomes effective, and hence images are rendered to the output device as usual but, the rendering operation outside the mask becomes ineffective and hence the rendering is not reflected in the output device (403). By clearing the mask, all the rendering operations become effective as usual.

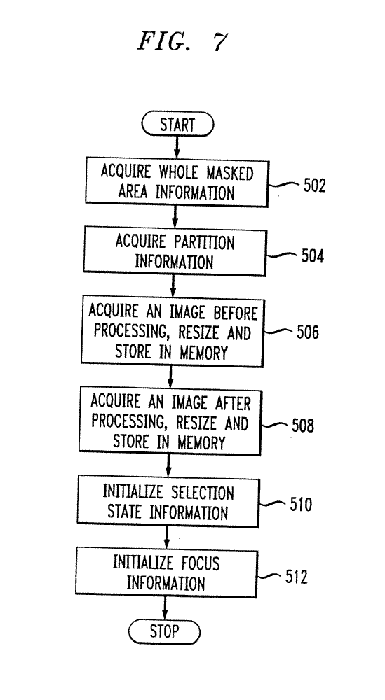

The initial setting before operation of the image comparing and selecting module 203 will be described by using FIG. 7. At step 502, the whole masked area information is acquired from the application program, and is held in the memory. Rendering by the image comparing and selecting module 203 is performed in this whole masked area. At step 504, partition information is acquired, and is held in the memory.

At steps 506 and 508, an image before processing and an image after processing are acquired from the application program, respectively. After resizing both images into sizes smaller than the width and height of the whole masked area at certain ratios, the images are held in the memory. The reason why the module 203 makes the images smaller than the whole masked area is to provide space for rendering a selection frame around each image.

Furthermore, at step 510, the module 203 sets selection state information in the state to either one of the image before processing and image after processing. Moreover, the module 203 sets focus information at the “outside of the whole masked area” at step 512 to finish the initial setting.

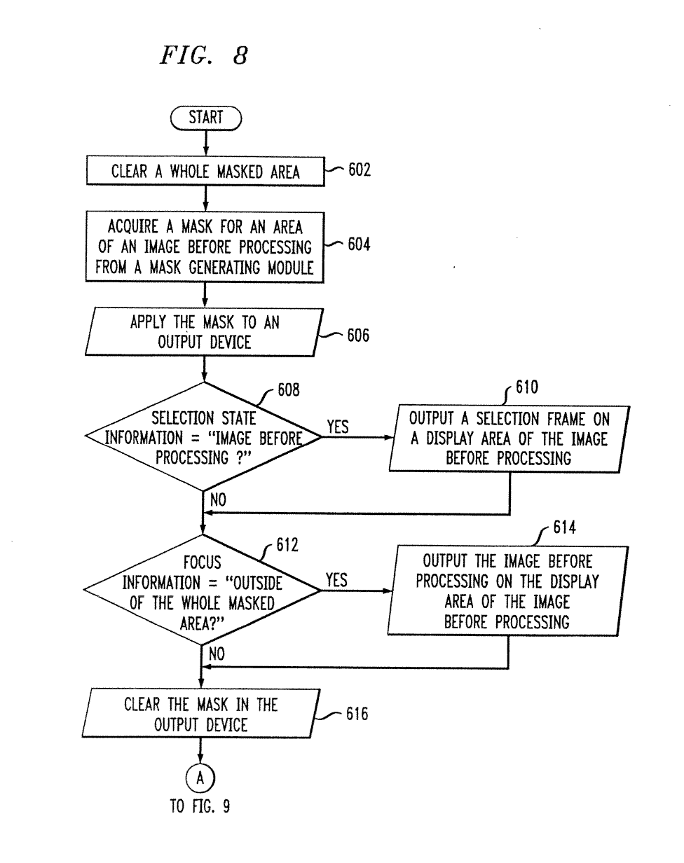

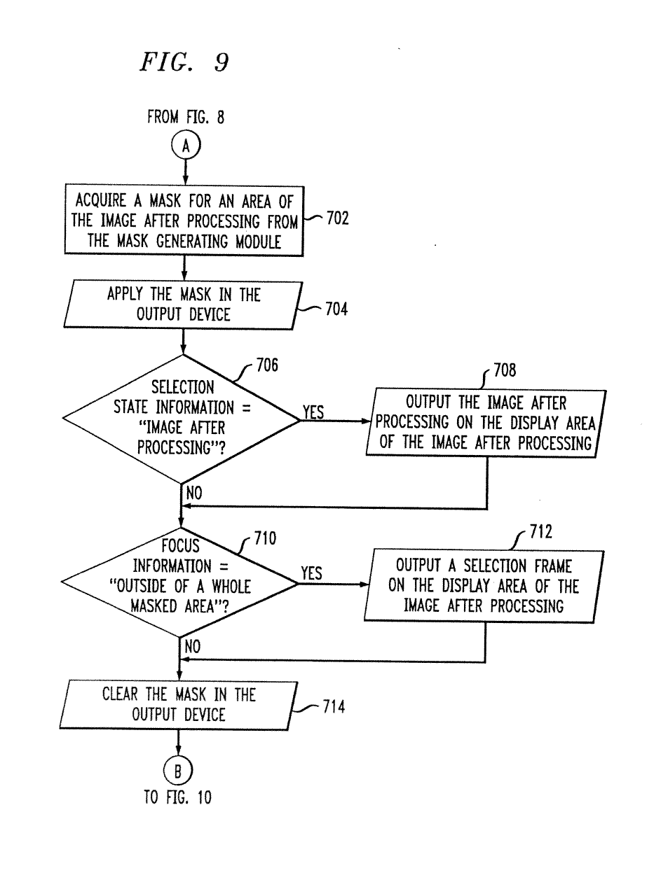

The operation of the rendering module 311 will be described by using FIGS. 8, 9, and 10. The rendering module 311 performs the rendering of the masked area of the image before processing or the masked area of the image after processing according to the selection state information. In addition, the module 311 performs the rendering of the image before processing or the image after processing in the whole image display area according to the focus information.

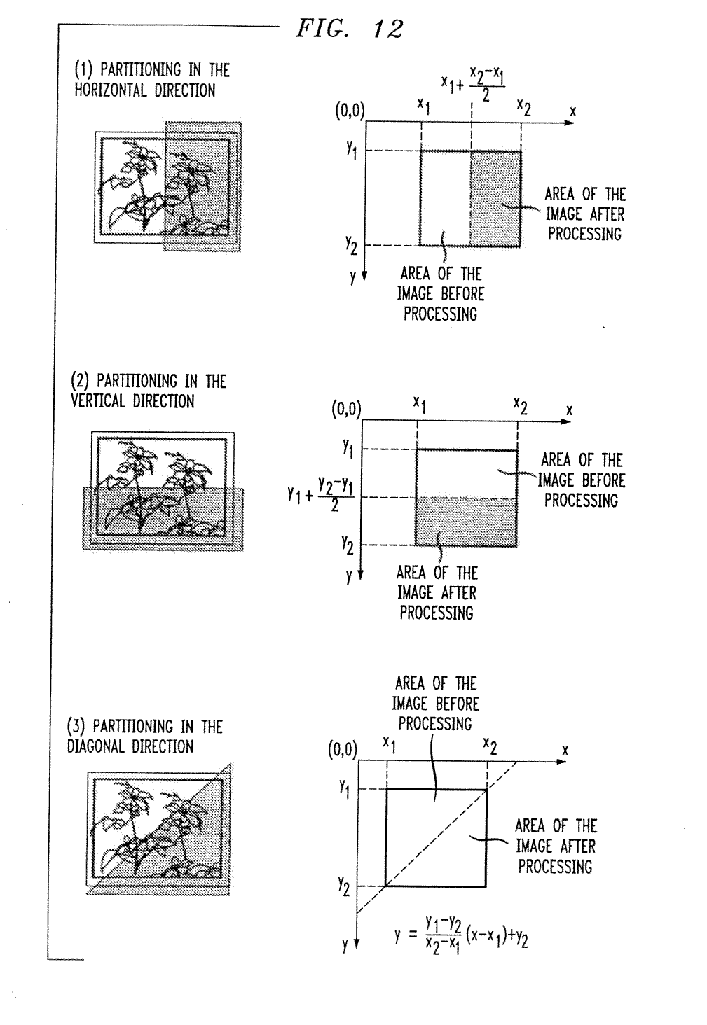

First, at step 602, the rendering module 311 clears the whole masked area by filling the area with a background color. Symbol 901 in FIG. 11 shows this state. Next, at step 604, the rendering module 311 acquires a mask for the masked area of the image before processing from the mask generating module. Then, at step 606, the rendering module 311 applies the mask to the output device. Owing to this operation, it is assured that the subsequent rendering operation is performed only on the masked area of the image before processing. Symbol 902 in FIG. 11 shows this state.

Next, at step 608, the rendering module 311 performs processing of step 610 if the selection state information is the “image before processing,” and fills the whole masked area with a selected color for the selection frame of the image before processing. However, since the mask of the image before processing is applied, only the masked area of the image before processing is actually filled. This state is shown by symbol 903 in FIG. 11. After that, since the image before processing is rendered in the area smaller than the masked area, the part outside the part where the image before processing is rendered is the selection frame of the image before processing filled with this selected color.

Next, at step 612, if the focus information is the “outside of the whole masked area,” the rendering module 311 performs processing of step 614, which is to render the image before processing. The rendering of the image is performed in an area whose width and height are smaller than those of the masked area. This is also to secure a display area for the selection frame. This state is shown by symbol 904 in FIG. 11. Therefore, if the filling at step 610 is performed, the state which the selection frame showing the selection of the image before processing which is rendered around the image is completed.

Furthermore, at step 616, the rendering module 311 clears the mask applied in the output device. Thus, the rendering of the masked area of the image before processing is completed.

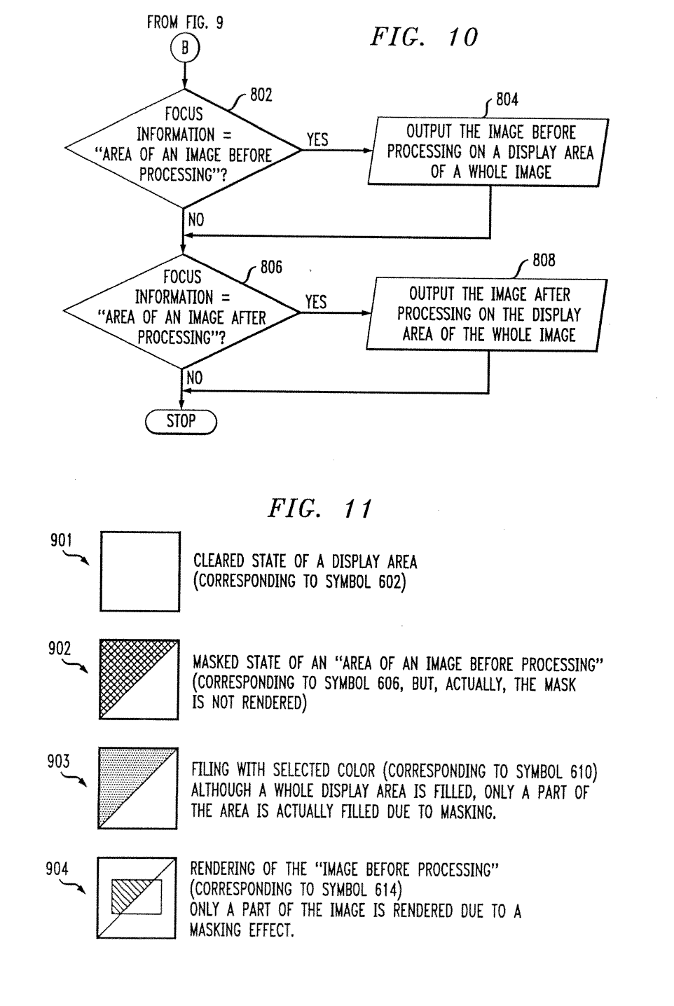

Next, at step 702 in FIG. 9, the rendering module 311 acquires the mask for the masked area of the image after processing from the mask generating module. Then, at step 704, the module 311 applies the mask in the output device. Due to this operation, the subsequent rendering operation is performed only on the masked area of the image after processing, and the rendering is not performed on the masked area of the image before processing where the rendering module 311 rendered previously.

Next, at step 706, the rendering module 311 performs processing of step 708 if the selection state information is the “image after processing,” and fills the whole masked area with a selected color for the selection frame of the image after processing. However, only the masked area for the image after processing is actually filled.

Next, at step 710, if the focus information is the “outside of the whole masked area,” the rendering module 311 performs processing at step 712, which is to render the image after processing. The rendering of the image is performed in an area whose width and height are smaller than those of the masked area. This is also to secure a display area for the selection frame showing the selection of the image after processing.

Furthermore, at step 714, the rendering module 311 clears the mask applied in the output device. Thus, the rendering of the masked area of the image after processing is completed.

Finally, the following describes the rendering in the case where the focus information is the “inside of the masked area of the image before processing” or the “inside of the masked area of the image after processing,” that is, the case that the cursor of the pointing device is inside either one of the masked areas.

At step 802 in FIG. 10, if the focus information is the “inside of the masked area of the image before processing,” the rendering module 311 performs processing of step 804, which is to render the whole image of the image before processing on the whole image display area.

Similarly, at step 806, if the focus information is the “inside of the masked area of the image after processing,” the rendering module 311 performs processing of step 808, which is to render the whole image of the image after processing on the whole image display area.

At steps 610 and 708, colors of selection frames of the image before processing and image after processing which are distinct colors held as a constant are stored in the image comparing and selecting module 203. This is to make it easier to distinguish which is selected, by rendering the selection frames by using different colors.

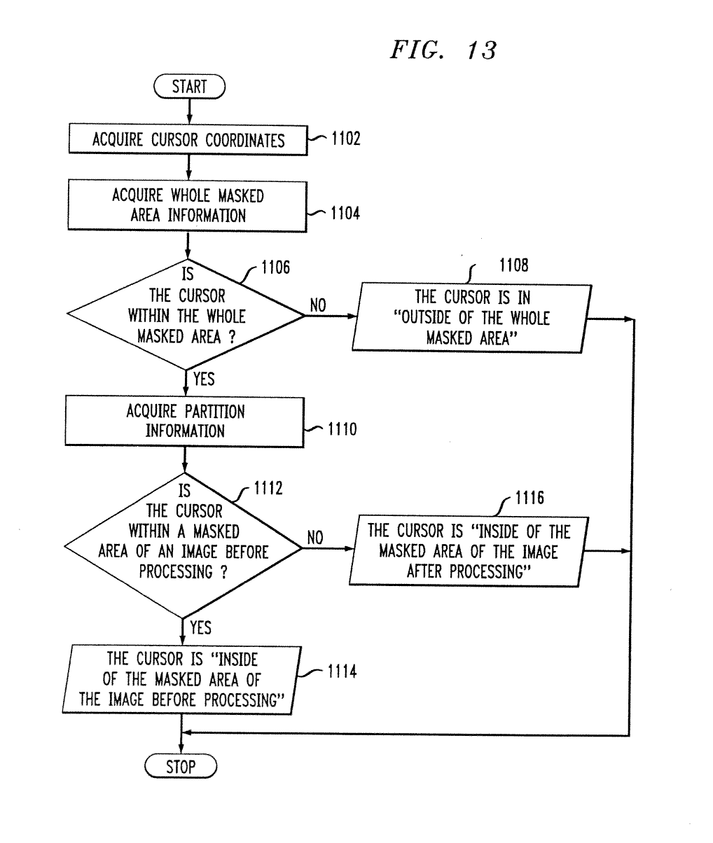

The operation of the mask generating module 310 will be described by using FIG. 12.

In addition, regarding partition methods of the masked area of the image before processing and the masked area of the image after processing, that is, the three cases, (1) partitioning in the horizontal direction, (2) partitioning in the vertical direction, and (3) partitioning in the diagonal direction, are cited and described as examples. Nevertheless, those skilled in the art can understand as a matter of course that various partitioning methods besides these are available.

The mask generating module 310 is called by the rendering module 311, and returns the mask for the masked area of the image before processing or the masked area of the image after processing according to a request from the rendering module 311. As shown in FIG. 12, assuming that in the coordinate system the upper left point is the origin, and coordinates of the upper left point of the rectangular masked area are (x1, y1) and those of the lower right point are (x2, y2), the partition is expressed as follows.

If the partition information is “partitioning in the horizontal direction” as shown in FIG. 12(1), the mask for the masked area of the image before processing becomes a rectangle whose corner coordinates are (x1, y1) in the upper left corner and (x1+(x2−x1)/2, y2) in the lower right corner.

On the other hand, the mask for the masked area of the image after processing becomes a rectangle whose corner coordinates are ((x2−x1)/2, y1) in the upper left corner and (x2, y2) in the lower right corner.

If the partition information is “partitioning in the vertical direction” as shown in FIG. 12(2), the mask for the masked area of the image before processing becomes a rectangle whose corner coordinates are (x1, y1) in the upper left corner and (x2, y1+(y2−y1)/2) in the lower right corner.

On the other hand, the mask for the masked area of the image after processing becomes a rectangle whose corner coordinates are (x1, y1+(y2−y1)/2) in the upper left corner and (x2, y2) in the lower right corner.

If the partition information is “partitioning in the diagonal direction” as shown in FIG. 12(3), the mask for the masked area of the image before processing becomes a triangle that is composed by connecting three points of a point (x1, y1), a point (x2, y1), and a point (x1, y2).

On the other hand, the mask for the masked area of the image after processing becomes a triangle that is composed by connecting three points of a point (x2, y1), a point (x1, y2), and a point (x2, y2).

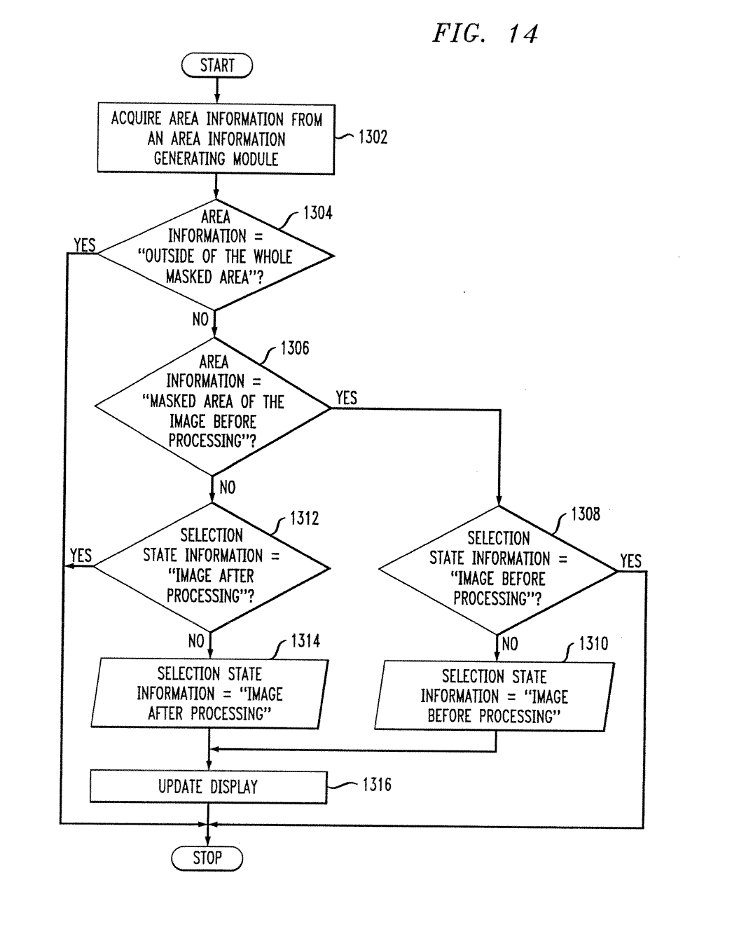

Next, the operation of the area detecting module 308 will be described by using FIGS. 12 and 13. The area detecting module 308 is called by the selection state information generating module 304 or focus information generating module 306. The function of the area detecting module 308 is to return the information of an area where the cursor is present, that is, whether the current cursor is “outside of the whole masked area,” “inside of the masked area of the image before processing,” or “inside of the masked area of the image after processing.”

First, at step 1102 in FIG. 13, the area detecting module 308 acquires the present coordinates of the cursor of the pointing device from the OS. At step 1104, the module 308 acquires whole masked area information. At step 1106, the module 308 decides whether the cursor is on the whole masked area. If the cursor is not on the whole masked area, the area detecting module 308 returns the information of “outside of the whole masked area” at step 1108, and the process is finished.

If the cursor is on the whole masked area, the area detecting module 308 acquires partition information at step 1110, and decides whether the cursor is on the masked area of the image before processing or the masked area of the image after processing. The whole masked area is partitioned according to the partition information into two parts: the masked area of the image before processing; and the masked area of the image after processing. The area where the cursor is located is decided by the following formula.

As shown in FIG. 12, the position of the cursor is (x, y), coordinates of the upper left point of the display area are (x1, y1), and coordinates of the lower right point are (x2, y2). If the following inequality is satisfied, it is decided at step 1112 that the cursor is “inside of the masked area of the image before processing.” If not, it is decided that the cursor is “inside of the masked area of the image after processing.”

If the partition information is “partitioning in the horizontal direction” as shown in FIG. 12(1) and the inequality, x<x1+(x2−x1)/2 is satisfied, it is decided that the cursor is inside the masked area of the image before processing.

If the partition information is “partitioning in the vertical direction” as shown in FIG. 12(2) and the inequality, y<y1+(y2−y1)/2 is satisfied, it is decided that the cursor is inside the masked area of the image before processing.

If the partition information is “partitioning in the diagonal direction” as shown in FIG. 12(3) and the inequality, y<(y1−y2)/(x2−x1)′(x−x1)+y2 is satisfied, it is decided that the cursor is inside the masked area of the image before processing.

By the above-described algorithm, the area detecting module 308 returns the information of “inside of the masked area of the image before processing” at step 1114, or the information of “inside of the masked area of the image after processing” at step 1116 to complete the processing in the area detecting module 308.

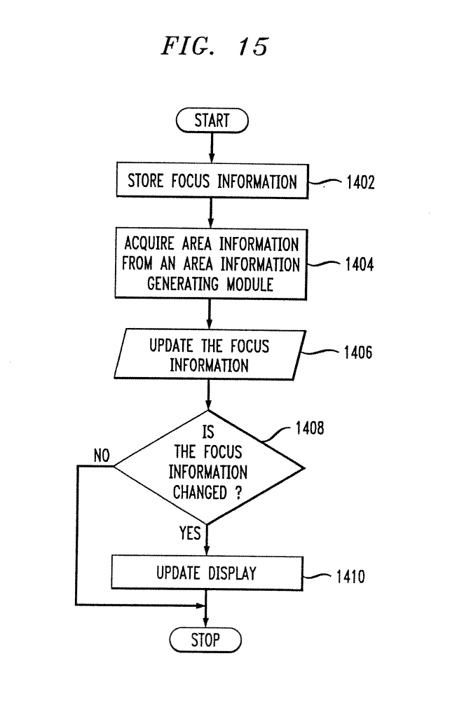

The operation of the selection state information generating module 304 will be described by using FIG. 14. The selection state information generating module 304 starts its operation when a button of the pointing device is clicked. Furthermore, the module 304 updates the selection state information according to coordinates of the cursor when it is clicked.

First, at step 1302, the selection state information generating module 304 asks the area detecting module 308 where the cursor is located, and acquires area information.

If the information of “outside of the whole masked area” from the area detecting module 308 at step 1304 is acquired, the selection state information generating module 304 finishes the processing without updating the contents of the selection state information. If the information of “inside of the masked area of the image before processing” from the area detecting module 308 at step 1306 is acquired, the selection state information generating module 304 checks the current selection state information at step 1308. If the “image before processing” is not selected, the selection state information generating module 304 makes the selection state information the “image before processing” at step 1310. Thereafter, the module 304 calls the rendering module 311 at step 1316 to make the module 311 update display.

If the information from the area detecting module 308 is neither “outside of the whole masked area” nor “inside of the masked area of the image before processing,” but is “inside of the masked area of the image after processing,” the selection state information generating module 304 checks the current selection state information at step 1312. If the “image after processing” is not selected, the selection state information generating module 304 updates the selection state information to the “image after processing” at step 1314. Thereafter, the module 304 calls the rendering module 311 at step 1316 to make the module 311 update display.

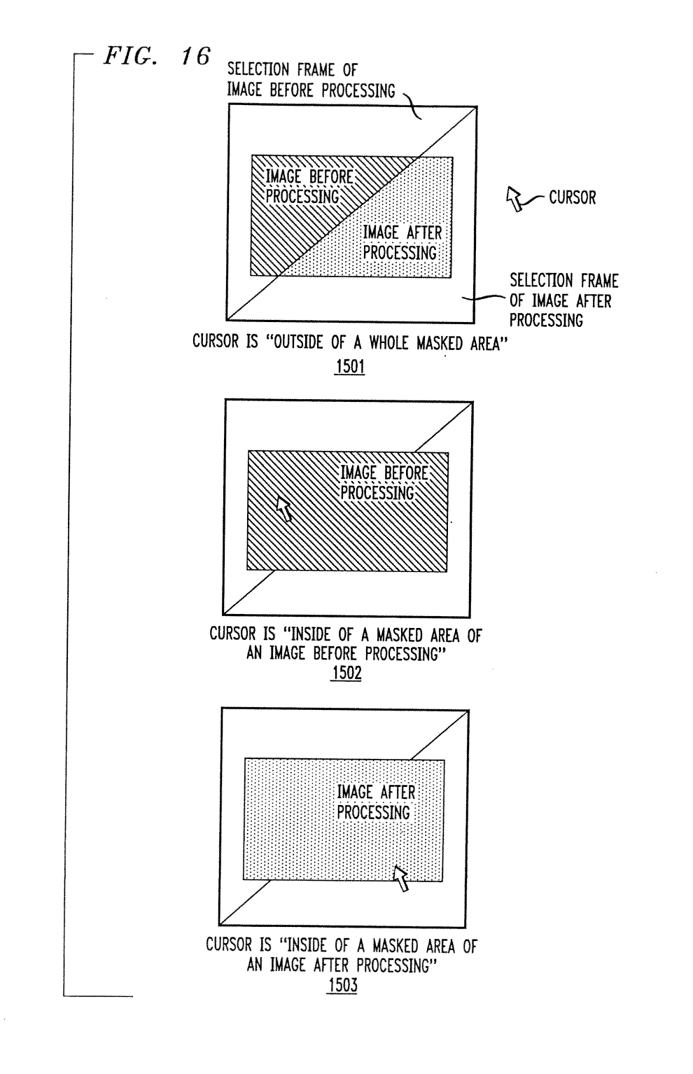

Next, the operation of the focus information generating module 306 will be described with using FIG. 15. The focus information generating module 306 starts its operation every time the cursor of the pointing device is moved, and updates focus information according to coordinates of the cursor. First, the module 306 stores current focus information at step 1402. Next, when the cursor is moved, the focus information generating module 306 activates the area information generating module, and acquires area information of the current cursor position from the area information generating module at step 1404.

Then, the focus information generating module 306 updates the focus information at step 1406, that is, makes the area information, which is acquired, the new focus information. At step 1408, the module 306 compares the new focus information with the focus information stored. If the focus information is changed, the module 306 calls the rendering module 311 to make the module 311 update display.

The focus information is either one of “outside of the whole masked area,” “inside of the masked area of the image before processing,” or “inside of the masked area of the image after processing.” Examples of display at respective states are shown in FIG. 16.

FIG. 16 illustrates an example of the “partitioning in the diagonal direction.” First, if the focus information is “outside of the whole masked area,” the display area is divided according to the partition information, and hence the image before processing and the image after processing are displayed together (1501).

Next, if the focus information is “inside of the masked area of the image before processing,” that is, the position of the cursor of the pointing device is inside the display area of the image before processing or inside the selection frame of the image before processing, the whole image of the image before processing is displayed on the display area (1502).

Furthermore, if the focus information is “inside of the masked area of the image after processing,” that is, the position of the cursor of the pointing device is inside the display area of the image after processing or inside the selection frame of the image after processing, the whole image of the image after processing is displayed on the display area (1503).

Thus, although the present invention is described with reference to an embodiment, those skilled in the art can easily understand that a wide range of different working modes can be formed on the basis of the present invention without departing from the idea and scope of the present invention.

For example, an application of the present invention is to have several display areas of whole images on one screen, and simultaneously display an image before processing and an image after processing for each image by dividing the whole image display area. In order to realize this, an image before processing and an image after processing, partition information, selection state information, and whole masked area information are made to be a set, these sets are held in the memory, and the image comparing and selecting module is sequentially applied to each set.

In addition, the present invention is not restricted to an invention such that an image before processing must be displayed, but it is possible to apply the present invention for comparison of several images after processing that are processed differently.

Thus, as an example application, one whole image display area is divided into two parts, that is, areas for an image before processing and an image after processing, and these images are displayed as described in an embodiment of the present invention. But, it is also possible to apply the present invention when the whole image display area is divided into three or more parts and comparison of images, which are results of different processing, can be performed.

Furthermore, although an embodiment of the present invention consists of one photographic image with an image before processing and an image after processing, it can be also performed on images before and after processing where the same part of the photographic image is simultaneously displayed.

Moreover, as an example, a display area is divided into three types of “partition in the vertical direction,” “partition in the horizontal direction,” and “partition in the diagonal direction” is described in an embodiment of the present invention. However, the present invention can be applied also to other various partitioning methods.

In addition, as an example selection frames whose color is different are displayed so as to easily find which image between images before and after processing is selected is described. However, a selection frame is not essential, and hence it may be unnecessary to display the selection frame, or if it is displayed, it will be apparent for those skilled in the art that it is possible to modify other attributes such as a pattern, and blinking of only one side of selection frame as well as color change.

In regard to image comparison, it is necessary to visually compare images, as closely as possible so as to compare subtle difference between an image before processing and an image after processing. The present invention facilitates image comparison by partitioning one image display area and simultaneously displaying images before and after processing or images that are results of different processing. In addition, in the present invention, it is possible to select several partitioning methods, and hence it is possible to compare images using user's legible methods.

Regarding image display, a user may sometimes want to see a whole image of each image besides seeing images with the partitioned image display area, when comparing the images. In this case, in the present invention, it is unnecessary to click a pointing device. Thus, a system detects a position of a cursor of the pointing device, and can display an image, which is displayed at the cursor position, on a whole image display area. Therefore, only by changing the cursor position, the user can easily switch image display to the desired display such as the display with partitioning an image before processing from an image after processing, the display of a whole image of the image before processing, and the display of a whole image of the image after processing.

In regard to image selection, it is possible to select an image before processing by moving a cursor to a masked area of an image before processing, that is, a whole image display area where a whole image of the image before processing is displayed, and clicking a button. On the other hand, by moving a cursor to a masked area of an image after processing, and clicking the button, it is possible to select the image after processing. In this manner, it can be easily performed to select the desired image.

In addition, a user can see at a glance which image is selected since either one of the selection frames, whose appearance are different when the image before processing is selected and when the image after processing is selected, is displayed around the image. Therefore, it is possible to provide a system whose usability is excellent.

It is to be understood that the embodiments and variations shown and described herein are merely illustrative of the principles of this invention and that various modifications may be implemented by those skilled in the art without departing from the scope and spirit of the invention.

What is claimed is:

1. A method of simultaneously displaying images after processing, which are results of different processing, on a whole image display area, comprising the steps of:
performing first processing to an image;
performing second processing to said image;
selecting an area to display the image after first processing on a part of the whole image display area;
selecting an area to display the image after second processing on a part of the whole image display area; and
simultaneously displaying the image after first processing, and the image after second processing on the whole image display area, wherein one or more steps of said method are performed by one or more hardware devices.

2. A method of simultaneously displaying a first image and a second image on a whole image display area, comprising the steps of:
acquiring whole masked area information;
acquiring partition information of a masked area of the first image and a masked area of the second image on the whole masked area;
applying the partition information to the whole masked area;
rendering a selection frame of the first image on the masked area of the first image corresponding to selection state information indicating the first image if a cursor of a pointing device is present outside the whole masked area;
outputting the first image on the masked area of the first image to remain a display area of the selection frame of the first image; and
outputting the second image on the masked area of the second image, wherein one or more steps of said method are performed by one or more hardware devices.

3. A method of simultaneously displaying a first image and a second image on a whole image display area, comprising the steps of:
acquiring whole masked area information;
acquiring partition information of a masked area of the first image and a masked area of the second image on the whole masked area;
applying the partition information to the whole masked area;
rendering a selection frame of the first image on the masked area of the first image if a cursor of a pointing device is present outside the whole masked area; and
outputting the second image on the masked area of the second image.

4. The method of claim 3, further comprising the steps of:
displaying a whole image of the first image on the whole image display area corresponding to the cursor being positioned in the masked area of the first image; and
displaying a whole image of the second image on the whole image display area with corresponding to the cursor being positioned in the masked area of the second image, wherein one or more steps of said method are performed by one or more hardware devices.

5. The method of claim 3, further comprising the steps of:
selecting the first image corresponding to the cursor being positioned in the masked area of the first image and being clicked; and
selecting the second image corresponding to the cursor being positioned in the masked area of the second image and being clicked, wherein one or more steps of said method are performed by one or more hardware devices.

6. A computer system for displaying images after processing, which are results of different processing, simultaneously on a whole image display area, comprising:
means for performing first processing to an image;
means for performing second processing to said image;
means for selecting an area to display the image after first processing on a part of the whole image display area;
means for selecting an area to display the image after second processing on a part of the whole image display area; and
means for simultaneously displaying the image after first processing and the image after second processing on the whole image display area.

7. An article of manufacture comprising a tangible computer readable recordable storage medium having computer readable instructions tangibly embodied thereon which, when implemented, cause a computer to carry out a plurality of method steps for displaying images after processing, which are results of different processing, simultaneously on a whole image display area, comprising the steps of:
performing first processing to an image;
performing second processing to said image;
selecting an area to display the image after first processing on a part of the whole image display area;
selecting an area to display the image after second processing on a part of the whole image display area; and
simultaneously displaying the image after first processing and the image after second processing on the whole image display area.
